(19) United States
(12) Patent Application Publication
(10) Pub. No.: US 2019/0059405 A1
(43) Pub. Date: Feb. 28, 2019

(54) METHOD FOR PREPARING CUT AND FROZEN VEGETABLES

(71) Applicant: INDUSTRIE ROLLI ALIMENTARI S.P.A., Roseto Degli Aruzzi (IT)

(72) Inventor: Gian Paolo ROLLI, Frazione S. Michele di Tiorre (IT)

(21) Appl. No.: 16/083,861

(22) PCT Filed: Mar. 8, 2016
(86) PCT No.: PCT/IT2016/000060

§ 371 Date: Sep. 10, 2018

(51) Int. Cl. A23B 7/04; A23B 7/05

(52) U.S. Cl. CPC A23B 7/0416; A23L 19/01; A23B 7/05

(57) ABSTRACT

A method for preparing cut and frozen vegetables including the step of washing the vegetables in order to eliminate any residues of soil or other substances and materials that may have accumulated during picking. In a subsequent step, it is necessary to subject the vegetables to a mechanical treatment in order to isolate their edible part. One then proceeds by cutting the vegetables into granules with sizes comprised between 30 mm³ and 60 mm³ by using a cutting device. At this point, one proceeds by immersing the granules in water for a predefined limited time. At a later time, one proceeds by scalding, with jets of hot water, the granules and air drying them.

### TECHNICAL FIELD

The present disclosure relates to a method for preparing cut and frozen vegetables and to the corresponding food provided according to the method.

These vegetables are of the type chosen among Brassicaceae (white cauliflower, green cauliflower, violet cauliflower, yellow cauliflower, Romanesco broccoli) and the like.

The innovation is a response to the growing interest toward this type of vegetable. Cauliflower, and in particular all types of cabbage, are in fact a healthy, balanced food that is rich in vitamins and mineral salts that are essential in any type of diet.

### BACKGROUND

The presence of calcium, potassium, sulfur, iodine, iron and phosphorus, as well as of vitamins A, B1, B2, C, K, PP and folic acid, makes these vegetables beneficial and energy-rich despite a low calorie content, only 25 cal per 100 g, and are therefore excellent even during weight loss diets.

Several scientific studies have pointed out their countless beneficial actions, above all the boosting of immune defenses, in view of the abundant presence of vitamins. Moreover, positive action against cholesterol and the onset of tumors, as well as anti-inflammatory, antioxidant, antibacterial and antiscorbutic powers, have been confirmed.

For example, the chlorophyll contained in green cabbage boosts the production of hemoglobin and is therefore very useful for people suffering from anemia.

Moreover, they contain no gluten and can be eaten safely even by diabetics.

In many countries the preparation of cauliflowers in a couscous version has become widespread, developing several recipes; therefore, they begin to constitute a valid alternative to rice and traditional couscous based on cereals, such as barley, millet, sorghum or corn.

Couscous preparations based on cauliflowers are offered commercially as fourth range products.

It is specified that fresh vegetables and horticultural products which, after picking, are subjected to minimal technological processes aimed at ensuring their hygienic safety and the enhancement of the product proper, such as for example fruit, vegetables and in general fresh vegetables packaged and ready for eating, are defined as fourth range products.

### SUMMARY

The aim of the present disclosure is to offer a commercial response to the need to have a frozen food product with these characteristics, proposing a method, and a corresponding food product provided according to the method, for preparing frozen cut vegetables that safeguards the organoleptic and nutritional properties and maintains the typical consistency of the fresh product that belong to the vegetables that constitute the product.

Within this aim, the disclosure offers a food product, constituted by vegetables, which is frozen and packaged and is easy and quick to prepare and has a useful commercial life, so-called shelf life, equal to at least 18 months.

The present disclosure also provides a frozen and packaged food product, constituted by vegetables, that once thawed for consumption maintains the typical consistency of the fresh vegetable, without being wet due to the presence of moisture that can be generated during the thawing of the product.

The present disclosure further provides a method for preparing cut and frozen vegetables that has low costs, is relatively simple to provide in practice and is safe in application.

This aim and these advantages are achieved by providing a method for preparing cut and frozen vegetables, which includes:
washing the vegetables in order to eliminate any residues of soil or other substances and materials that may have accumulated during picking;
subjecting said vegetables to a mechanical treatment in order to isolate their edible part;
cutting said vegetables into granules with sizes comprised between 30 mm³ and 60 mm³ by using a cutting device;
immersing said granules in water at a temperature comprised between 75° C. and 85° C. for a predefined time;
scalding, with jets of hot water at a temperature comprised between 75° C. and 85° C., said granules;
air drying said granules;
performing a manual sorting of the granules to identify any presence of defects therein;
freezing said granules by means of a freezer at a temperature comprised between −18° C. and −30° C.;
eliminating the presence of clumps or crumbs by using a vibrating screen device.

This aim and these advantages are also achieved by providing a frozen and packaged food product constituted by vegetables, characterized in that it comprises a container and vegetables subjected beforehand to washing, mechanical treatment and cutting to define granules with sizes comprised between 30 mm³ and 60 mm³.

### DETAILED DESCRIPTION OF THE DISCLOSURE

Further characteristics and advantages of the disclosure will become better apparent from the description of a preferred but not exclusive embodiment of the method for preparing cut and frozen vegetables and the corresponding food provided according to the method.

It is useful to specify that the vegetables can be of the type chosen preferably among Brassicaceae (white cauliflower, green cauliflower, violet cauliflower, yellow cauliflower, Romanesco broccoli) and the like.

It is specified that the vegetables can be any variety of cauliflower.

It is specified further that such food comprises a food product, constituted by vegetables, which is frozen and packaged and is characterized in that it comprises a container and vegetables subjected beforehand to washing, mechanical treatment and cutting to define granules with dimensions comprised between 30 mm³ and 60 mm³.

The method according to the disclosure includes washing the vegetables in order to eliminate any residues of soil or other substances and materials that may have accumulated during picking.

It is specified that the step of cleaning from the leaves can be performed directly at the picking site with a manual finish at the factory.

In a subsequent step it is necessary to subject the vegetables to a mechanical treatment in order to isolate their edible part.

The expression “mechanical treatment” is understood to designate all processes useful to isolate the edible part of the vegetable, eliminating everything that is unnecessary and/or superfluous for nutrition purposes.

The vegetable is then cut into granules with dimensions comprised between 30 mm³ and 60 mm³ by using a cutting device.

Such granules may have a shape preferably chosen among the granular shape of couscous, a grain of rice and the like.

At this point one proceeds by immersing the granules in water for a predefined limited time.

At a later time, one proceeds by scalding the granules with jets of hot water and drying them with air.

Both activities are performed with a water temperature comprised between 75° C. and 85° C.

Once the granules have been dried, one proceeds by performing a manual sorting of the granules in order to identify any presence of defects therein.

Finally, the granules are frozen individually by means of a freezer at a temperature comprised between −18° C. and −30° C.

This freezing method is also known as IQF freezing (acronym of Individually Quick Frozen), and indeed indicates the process by means of which the products are frozen individually.

According to a constructive solution of unquestionable interest in practice and in application, the method according to the disclosure can provide additional processing steps after freezing.

More particularly, in a first possible additional processing step, it is possible to package the granules in containers by using a packaging machine.

Such container can be constituted by a boxlike body, a pouch, a combination thereof and the like.

One then proceeds by checking, by using a device such as a metal detector, X-ray detectors and the like, for any presence of foreign items inside the containers.

In any case, the possibility is not excluded that these additional processing steps, which always follow the freezing step, might include packaging in vacuum these granules by using a pouch filling machine, followed by a step of checking, by using a device such as a metal detector, X-ray detectors and the like, for any presence of foreign items inside the pouches.

Once the checking step has ended, one then proceeds by inserting the containers or pouches, depending on the type of final packaging that is intended, in a secondary packaging, which is then subsequently arranged on a pallet.

The expression “secondary packaging” is understood to reference a packaging that is conceived so as to constitute, at the point of sale, the clustering of a certain number of sales units, regardless of whether it is sold as such to the end user or to the consumer, or it is used only to facilitate the resupply of the shelves at the point of sale.

It can be removed from the product without altering its characteristics (article 35, comma c), Legislative Decree no. 22/97).

The secondary packaging can constitute both the unit of sale intended for the end-user consumer and the unit intended for the retailer.

Finally, these pallets are stored within cold-storage rooms while waiting for final use. It is specified that the temperature inside such cold-storage rooms can be at least −20° C.

According to an embodiment solution of unquestionable efficiency and effectiveness, the step of packaging that follows the freezing step can provide for a substep that includes adding to the granules at least one precooked and frozen seasoning in pellet form in order to season the granules themselves.

This seasoning can be a juice, a sauce and the like.

The possibility to add the fresh unfrozen seasoning, in a form that is preferably chosen among liquid, partially solid and the like, after the freezing step is in any case not excluded.

In particular, the pellets according to the disclosure comprise a seasoning that is subjected beforehand to cooking, cooling, division into portions of predefined weight, and freezing.

The present disclosure is also aimed at protecting a food product, constituted by vegetables, which is frozen and packaged and comprises a container and vegetables subjected beforehand to washing, mechanical treatment, cutting in order to define granules with dimensions comprised between 30 mm³ and 60 mm³.

These granules can have a shape preferably chosen among the granular shape of couscous, a grain of rice and the like.

It is useful to specify that the vegetables can be of the type chosen preferably among Brassicaceae (white cauliflower, green cauliflower, violet cauliflower, yellow cauliflower, Romanesco broccoli) and the like.

It is specified that the vegetables can be any variety of cauliflower.

It is specified further that the vegetables used can comprise a residue of pesticides below a predefined threshold.

Such predefined threshold can be 0.01 mg/kg.

The agricultural process for obtaining the vegetables to be subsequently converted into frozen and packaged granules can be performed by following the provisions of guidelines for integrated production, i.e., a set of technical specifications and plant protection indications to be adopted in a binding manner for any crop and governed, in the Italian case, by appropriate regional guidelines.

These guidelines can in fact be applied more restrictively with the aim of ensuring a level of pesticide residue of less than 0.01 mg/kg.

Therefore, this condition allows to classify vegetables as “without residual pesticides” or “pesticide-free”.

It is specified that in order to render each batch of frozen and packaged food of agricultural origin traceable, all the data related to each step are cataloged in a specific database and are associated with a respective identification string (batch code provided on the containers with which the food product will be marketed).

However, the possibility that the vegetables used might be of the type that originates from organic farming is not excluded.

According to a preferred solution, the container can be constituted by a box-like body, a pouch, a combination thereof and the like.

The possibility that the container might be constituted by a cardboard box-like body provided with an inner lining layer made of a material such as ethylene vinyl alcohol (EVOH), polyamide (PA) and polyethylene (PE) is not excluded.

More particularly, the grammage of the cardboard can be preferably 300 g, while the grammage of the lining layer might be preferably 20 g.

In any case, the grammage of the box-like body and of the lining might be different.

Moreover, the possibility that the container is a tray provided with a film made of polymeric material for closure is not excluded.

Once the food has been eaten, it is therefore possible to separate the container from the closure film for their sorted recycling.

Moreover, there are various formats depending on the number of portions provided inside the food product.

The information of the food might be provided directly on the container or on a band that wraps around the packaging, if the container has the shape of a box-like body, for example a tray.

Such container can be constituted at least partially by at least one material selected among ethylene vinyl alcohol (EVOH), polyamide (PA), polypropylene (PPL), polyethylene (PE), lignin, Cartene, corn-derived polymers, (vegetable) cellulose, paper, cardboard, that is resistant to microwaves.

It is therefore possible for the consumer to cook such vegetable in a pan or by means of a conventional oven or microwave oven.

If cooking by microwave oven is used, it is specified that such container, since it is resistant to microwaves, can also be used as a cooking vessel and optionally as a dish within which the vegetable contained therein is to be consumed after microwave cooking, simplifying and optimizing the entire process of use of the food product.

According to a different solution that is particularly effective and efficient, the container can be constituted at least partially by ethylene vinyl alcohols (EVOH), polyamide (PA), polyethylene (PE) in order to render the container recyclable.

This constructive solution allows to obtain a container that can be recyclable for a percentage comprised between 96% and 98%.

According to another solution that is particularly effective and efficient, the container can be constituted at least partially by lignin, Cartene, corn-derived polymers, (vegetable) cellulose, in order to render the container compostable.

The food product according to the disclosure may further comprise at least one pellet that contains a precooked and frozen seasoning for seasoning the granules.

In any case, the possibility is not excluded that the food product might comprise a fresh, non-frozen seasoning, in a form chosen preferably among liquid, partially solid and the like.

This seasoning can be a juice, a sauce and the like.

The process for division into pellets is necessary in order to be then able to dose correctly the quantity of frozen seasoning according to the recipe provided by each finished food product that one wishes to obtain.

The use of salt or other seasonings can be left to the discretion of the consumer and they can be added after cooking has been completed.

Furthermore, the seasoning can comprise at least one element chosen among vegetables, meat, fish, cheese, oil and the like.

Advantageously, the method and the corresponding food product provided according to the method, for preparing cut and frozen vegetables, allows to safeguard the organoleptic and nutritional properties of the vegetables that constitute the product.

By freezing, in fact, the nutritional and organoleptic properties of the vegetable are preserved better, since it is processed when fresh within 24 hours of picking.

Usefully, the frozen and packaged food product, constituted by vegetables, is easy and quick to prepare and has a so-called useful shelf life of at least 18 months.

Effectively, the frozen and packaged food product, constituted by vegetables, once thawed for consumption, maintains the typical consistency of the fresh vegetable, without being wet due to the presence of moisture that can be generated during the thawing of the product.

This innovative property is achieved by means of the method for preparing cut and frozen vegetables according to the disclosure and in particular by means of the step of immersion in water, followed directly by the scalding step (both of these steps are performed with water at a temperature comprised between 75° C. and 85° C.), by the air drying treatment and by the freezing step.

The disclosure thus conceived is susceptible of numerous modifications and variations, all of which are within the scope of the appended claims; all the details may further be replaced with other technically equivalent elements.

In the examples of embodiment shown, individual characteristics, given in relation to specific examples, may actually be interchanged with other different characteristics that exist in other exemplary embodiments.

In practice, the materials used, as well as the dimensions, may be any according to requirements and to the state of the art.

1-17. (canceled)

18. A method for preparing cut and frozen vegetables, the method including the following steps:
washing the vegetables in order to eliminate any residues of soil or other substances and materials that may have accumulated during picking;
subjecting said vegetables to a mechanical treatment in order to isolate their edible part;
cutting said vegetables into granules with sizes comprised between 30 mm³ and 60 mm³ by using a cutting device;
immersing said granules in water at a temperature comprised between 75° C. and 85° C. for a predefined time;
scalding, with jets of hot water at a temperature comprised between 75° C. and 85° C., said granules;
air drying said granules;
performing a manual sorting of the granules to identify any presence of defects therein;
freezing said granules by means of a freezer at a temperature comprised between −18° C. and −30° C.; and
eliminating the presence of clumps or crumbs by using a vibrating screen device.

19. The method according to claim 18, wherein said vegetables are chosen among white cauliflower, green cauliflower, violet cauliflower, yellow cauliflower, and Romanesco broccoli.

20. The method according to claim 18, further including the following steps:
packaging said granules in containers by using a packaging machine; and
checking, by using a device such as a metal detector, and X-ray detectors, for any presence of foreign items inside said containers.

21. The method according to claim 18, further including the following steps:
packaging said granules in vacuum by using a pouch insertion machine; and
checking, by using a device such as a metal detector or an X-ray detectors, for any presence of foreign items inside said pouches.

22. The method according to claim 21, wherein said step of packaging follows the freezing step and provides for a sub-step that further includes:
adding to said granules at least one pellet that contains a precooked and frozen seasoning in order to season said granules.

23. A frozen and packaged food product constituted by vegetables, comprising a container and vegetables subjected beforehand to washing, mechanical treatment, and cutting to form granules with dimensions comprised between 30 mm³ and 60 mm³.

24. The food product according to claim 23, wherein said vegetables are chosen among white cauliflower, green cauliflower, violet cauliflower, yellow cauliflower, and Romanesco broccoli.

25. The food product according to claim 23, wherein said vegetables comprise a pesticide residue lower than a predefined threshold of 0.01 mg/kg.

26. The food product according to claim 23, wherein said vegetables originate from organic farming.

27. The food product according to claim 23, wherein said container is constituted by a box-like body, a pouch, and a combination thereof

28. The food product according to claim 23, wherein said container is at least partially constituted by at least one material selected among ethylene vinyl alcohols (EVOH), polyamide (PA), polyethylene (PE), lignin, Cartene, corn-derived polymers, (vegetable) cellulose, paper, and cardboard, said container being microwave-resistant.

29. The food product according to claim 23, wherein said container is constituted by at least one material of ethylene vinyl alcohol (EVOH), polyamide (PA), and polyethylene (PE) in order to render said container at least partially recyclable.

30. The food product according to claim 23, wherein said container is constituted by at least one material of lignin, Cartene, corn-derived polymers, (vegetable) cellulose, paper, and cardboard, in order to render said container compostable.

31. The food product according to claim 23, comprising a seasoning for seasoning said granules.

32. The food product according to claim 23, comprising at least one pellet that contains a precooked and frozen seasoning for seasoning said granules.

33. The food product according to claim 23, wherein said precooked and frozen seasoning comprise at least one element chosen among vegetables, meat, fish, cheese, and oil.
